(19) United States
(12) Patent Application Publication
(10) Pub. No.: US 2011/0307453 A1
(43) Pub. Date: Dec. 15, 2011

(54) INFORMATION PROCESSING APPARATUS, INFORMATION PROCESSING METHOD, AND PROGRAM

(75) Inventor: Tetsuo Maruyama, Tokyo (JP)

(73) Assignee: Sony Corporation, Tokyo (JP)

(21) Appl. No.: 13/154,711

(22) Filed: Jun. 7, 2011

(30) Foreign Application Priority Data
Jun. 14, 2010 (JP) P2010-135056

(51) Int. Cl. G06F 17/30

(52) U.S. Cl. 707/687; 707/E17.005

(57) ABSTRACT

There is provided an information processing apparatus including: a database in which content information, content-related information, and unit information are registered; a unit information receiving unit receiving the unit information, which was generated by connecting the content-related information to the content information, from an operation terminal; an overlapping registration confirming unit confirming whether unit information that overlaps the received unit information is registered in the database; an overlapping registration notifying unit notifying, via the operation terminal, an operator of the confirmation result; a credibility confirming unit operable when overlapping registration has not been found, to confirm credibility of the unit information based on verification information registered in one of the database and an external database; a credibility notifying unit notifying, via the operation terminal, the operator of the confirmation result; and a unit information registering unit registering the unit information whose credibility has been confirmed in the database.

### BACKGROUND OF THE INVENTION

1. Field of the Invention

The present disclosure relates to an information processing apparatus, an information processing method, and a program.

2. Description of the Related Art

An information providing service that provides the user with content information of content, such as (television) programs, book media, music media, video media, and game media, and content-related information relating to advertisements, products, services and other content and the like relating to such content is known (see Japanese Laid-Open Patent Publication No. 2009-33449). A service provider generates unit information that connects the content-related information to the content information and provides such unit information to the user. The user acquires the unit information, views the content information and, by way of the content-related information (for example, by viewing advertisements relating to the content), purchases a product or service relating to the content of the content information or views other content related to such content.

### SUMMARY OF THE INVENTION

Here, on the service provider side, the content information, the content-related information, and the unit information are managed as a database. Suitable content-related information is connected to the content information after confirming the relationship between the content information and the content-related information. However, in some cases, all of the content-related information that should be connected to certain content information will not be managed. It is also common for suitable content-related information that satisfies the needs of users to not be connected to content information. In some cases, the service provider side allows access to the database and outsources the connecting of content-related information to an external operator. However, in such situation, there will still be cases where suitable content-related information that satisfies the needs of users is not connected. For this reason, service providers have not always been able to provide users with high-quality user information where suitable content-related information is connected to content information and users have not been able to use such high-quality user information.

For this reason, the present disclosure aims to provide an information processing apparatus, an information processing method, and a program that are capable of providing high-quality unit information where suitable content-related information is connected to content information.

According to an embodiment of the present disclosure, there is provided an information processing apparatus including a database in which content information, content-related information, and unit information are registered, a unit information receiving unit receiving the unit information, which has been generated by connecting the content-related information to the content information, from an operation terminal, an overlapping registration confirming unit confirming whether unit information that overlaps the received unit information is registered in the database, an overlapping registration notifying unit notifying, via the operation terminal, an operator of a confirmation result of the overlapping registration confirming unit, a credibility confirming unit operable when overlapping registration has not been found, to confirm credibility of the unit information based on verification information registered in one of the database and an external database, a credibility notifying unit notifying, via the operation terminal, the operator of a confirmation result of the credibility checking unit, and a unit information registering unit registering the unit information whose credibility has been confirmed in the database.

The credibility confirming unit may split the unit information into the content information and the content-related information and verify credibility of a relationship between the content information and the content-related information based on the verification information registered in one of the database and the external database.

The unit information registering unit may provisionally register unit information whose credibility has not been confirmed for a specified period and is operable when the credibility has been confirmed within the specified period, to register the unit information whose credibility has been confirmed in the database.

The information processing apparatus may further include a connection rule confirming unit confirming whether suitable content-related information has been connected to the content information according to specified connection rules, and a connection rule notifying unit notifying, via the operation terminal, the operator of a confirmation result of the connection rule confirming unit.

The unit information receiving unit may receive, from the operation terminal, unit information generated by connecting at least one of content-related information registered in the database and content-related information generated by the operator to the content information.

The unit information receiving unit may receive content-related information generated by the operator from the operation terminal, and the unit information registering unit may register the received content-related information in the database.

The information processing apparatus may further include an information accessing unit allowing the operator to access the content information, the content-related information, and the unit information registered in the database to enable the operator to generate the unit information.

The information processing apparatus may further include a unit information transmitting unit transmitting the unit information to a use terminal, a usage log receiving unit receiving, from the use terminal, a usage log showing usage of the user information, and a usage log registering unit registering the usage log in association with the unit information.

The information processing apparatus may further include a usage log notifying unit notifying, via the operation terminal, the operator of the usage log of the unit information generated by the operator.

The information processing apparatus may further include a service providing unit providing, based on the usage log of the unit information generated by the operator, the operator with a service in keeping with usage of the unit information.

According to another embodiment of the present disclosure, there is provided an information processing method carried out by a computer, including steps of receiving unit information, which has been generated by connecting content-related information to content information, from an operation terminal, confirming whether unit information that overlaps the received unit information is registered in a database, notifying, via the operation terminal, an operator of a confirmation result for overlapping registration, confirming, when overlapping registration has not been found, credibility of the unit information based on verification information registered in one of the database and an external database, notifying, via the operation terminal, the operator of a confirmation result for the credibility, and registering the unit information whose credibility has been confirmed in the database.

According to another embodiment of the present disclosure, there is provided a program for causing a computer to execute the information processing method

According to the embodiments of the present disclosure described above, it is possible to provide an information processing apparatus, an information processing method, and a program that are capable of providing high-quality unit information where suitable content-related information is connected to content information.

### BRIEF DESCRIPTION OF THE DRAWINGS

FIG. 1 is a diagram showing an overview of an information providing system according to an embodiment of the present disclosure;

FIG. 2 is a block diagram showing the main functional configuration of an information providing apparatus;

FIG. 3 is a diagram showing the configuration of a database;

FIG. 4 is a diagram showing the configuration of unit information;

FIG. 5 is a sequence chart showing the main operation of the information providing system;

FIG. 6 is a diagram schematically showing a connecting method for program information and program-related information;

FIG. 7 is a diagram schematically showing the result of confirming connection rules;

FIG. 8 is a diagram showing how the result of confirming the connection rules is reported;

FIG. 9 is a diagram schematically showing a result of confirming whether there is overlapping registration;

FIG. 10 is a diagram showing how the result of confirming overlapping registration is reported;

FIG. 11 is a diagram schematically showing the result of confirming credibility; and

FIG. 12 is a diagram showing how the result of confirming credibility is reported.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### 1. OVERVIEW OF INFORMATION PROVIDING SYSTEM

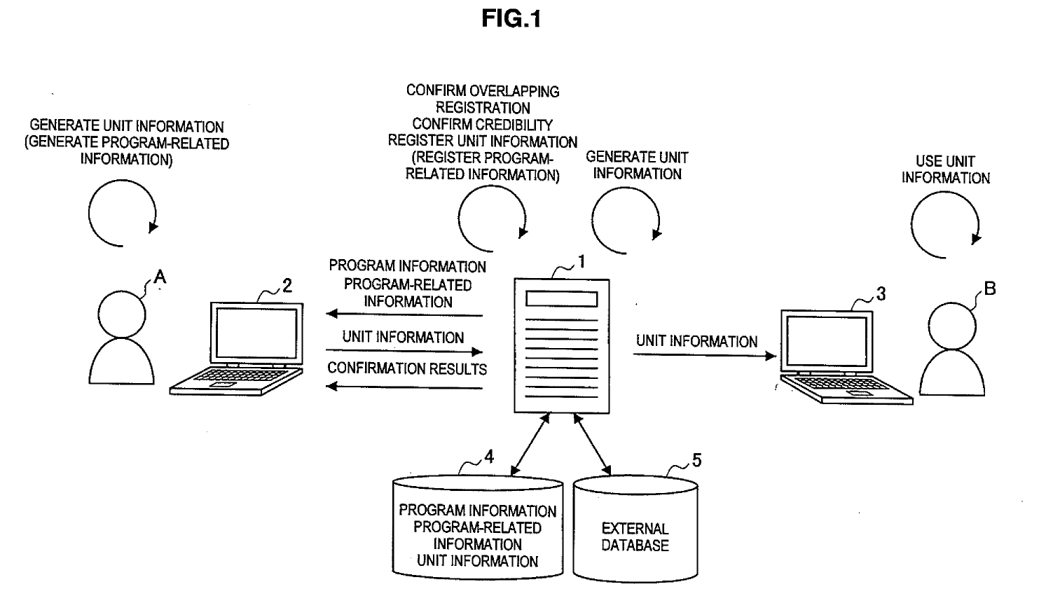

First, an overview of an information providing system according to an embodiment of the present disclosure will be described with reference to FIG. 1. FIG. 1 is a diagram showing an overview of an information providing system according to an embodiment of the present disclosure. Note that the following explanation uses a program as an example of content and describes a case where related information (content-related information) relating to a program is provided to a user together with program information (content information).

As shown in FIG. 1, the information providing system includes an information providing apparatus 1 (“information processing apparatus”) and an operation terminal 2 and a use terminal 3 that are capable of connecting to the information providing apparatus 1. The operation terminal 2 and the use terminal 3 are connected to the information providing apparatus 1 via a communication network (not shown) that may be wired or wireless. Note that the operation terminal 2 and the use terminal 3 are classified in this way out of convenience based on their functional roles in the system and may be constructed as the same terminal. It is also possible for the operation terminal 2 and the use terminal 3 to each be constructed from two or more terminals.

The information providing apparatus 1 is an information processing apparatus such as a server apparatus that is operated by a service provider that realizes an information providing service. The information providing apparatus 1 manages program information P (the general name for program information), program-related information R (the general name for program-related information) and unit information U (the general name for unit information), in which the program-related information R is connected to the program information P, using a database 4 and is also connected to an external database 5 (the general name for external databases) via a communication network (not shown). The operation terminal 2 is an information processing apparatus such as a personal computer or a mobile information terminal operated by an operator A who is external to the service provider. The use terminal 3 is an information processing apparatus operated by a user B who uses the unit information U.

The information providing apparatus 1 provides the unit information U, where the program-related information R is connected to the program information P, to the user B via the use terminal 3. The operation terminal 2 provides the unit information U generated by connecting the program-related information R to the program information P via the information providing apparatus 1 to a service provider (not shown). To enable usage by the user B, the use terminal 3 acquires the unit information U from the information providing apparatus 1.

Here, the expression “program information P” refers to information relating to the title, cast, producer, provider, release date/time, summary, and the like of a program. The expression “program-related information R” refers to information relating to advertisements, products, services, other programs and the like that relate to a program. The program-related information R may be information relating to one out of the title, cast members, producer, provider, release date/time, summary, and the like of the program or may be information relating to two or more of such information.

The expression “unit information U” relates to information in which information (“program-related information R”) relating to a program is connected to the program information P of such program. Note that the program-related information R of a program may include the program information P of another program. The unit information U will be described in detail later, but is composed of the program information P, the program-related information R, and connection information C (the general name for connection information) that connects the program-related information R to the program information P.

In this information providing system, high-quality unit information U in which suitable program-related information R is connected to the program information P is provided by the processing described below. First, in the information providing apparatus 1, unit information U generated by connecting the program-related information R to the program information P is received from the operation terminal 2. Here, the program information P is acquired from the database 4 and the program-related information R may be acquired from the database 4 or may be generated by the operator A.

Next, it is confirmed whether unit information U that overlaps the received unit information U is already registered in the database 4, and the result of confirming whether overlapping information is registered is reported to the operator A via the operation terminal 2. If it is confirmed that overlapping information has not been registered, the credibility of the unit information U is confirmed based on verification information E (the general name for verification information) registered in the database 4 or the external database 5, and the result of confirming the credibility is reported to the operator A via the operation terminal 2. After this, the unit information U whose credibility has been confirmed is registered in the database 4.

Here, the “credibility” of the unit information U shows whether some kind of direct or indirect actual relationship is confirmed between the program information P and the program-related information R included in the unit information U. As one example, for an advertisement, product, service, or other program relating to a program, a direct actual relationship with the program is confirmed, while for an advertisement, product, service, or other program relating to another program made by the same producer, an indirect actual relationship with the program is confirmed.

Unit information U generated by the service provider and/or unit information U generated by the operator A is provided to the user B. By avoiding overlapping registration of unit information U and confirming the credibility of the unit information U in this way, it is possible to provide high-quality unit information U in which suitable program-related information R that satisfies the demands of the user B is connected to the program information P.

In accordance with the provision of the unit information U, the information providing apparatus 1 also receives a usage log showing usage of the unit information U. The operator A who generated the unit information U is informed of the usage log of the unit information U and is provided with a service, reward, or the like in keeping with the usage of the unit information U from a provider (advertising business, product/service provider, program provider, or the like) of the program-related information R included in the unit information U.

### 2. CONFIGURATION OF INFORMATION PROVIDING APPARATUS 1

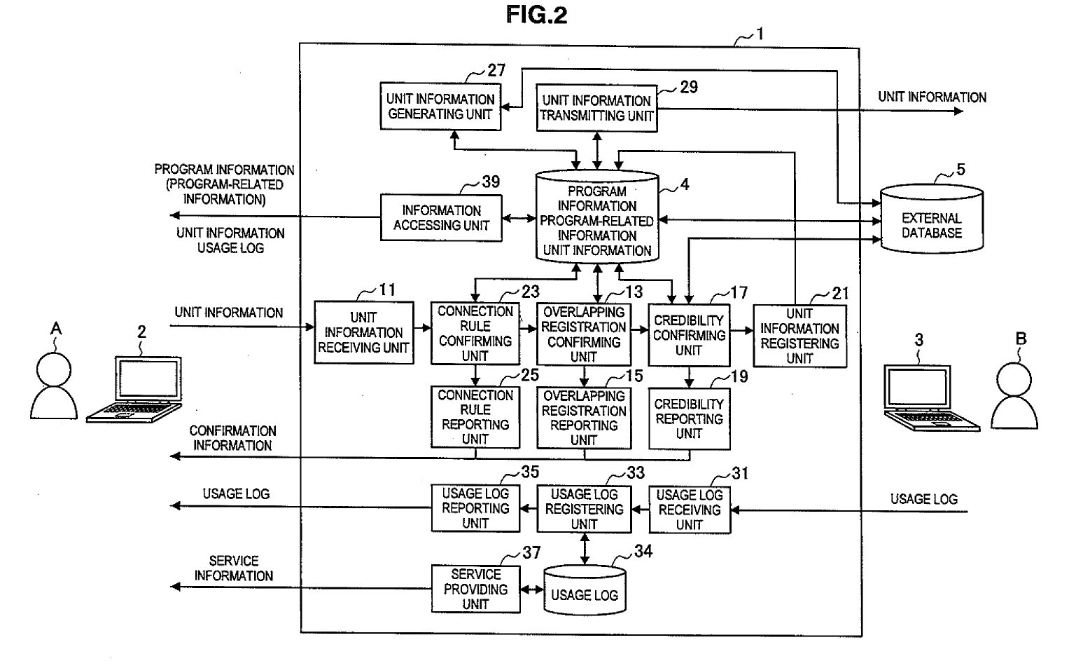

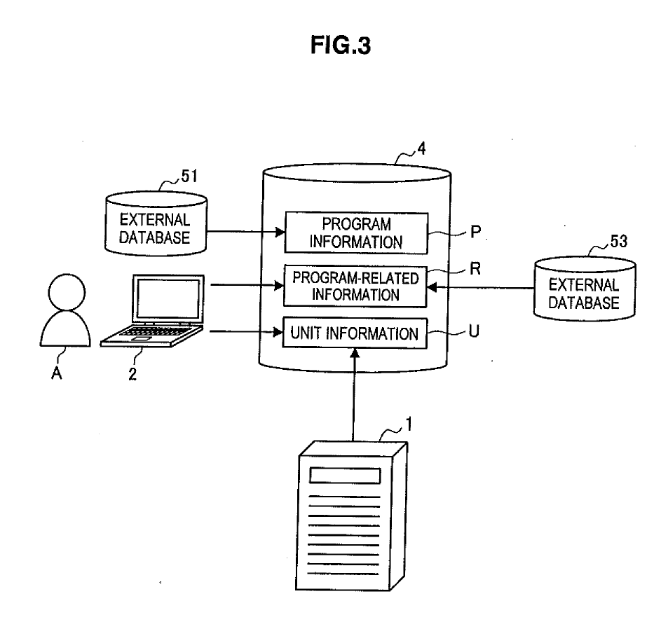

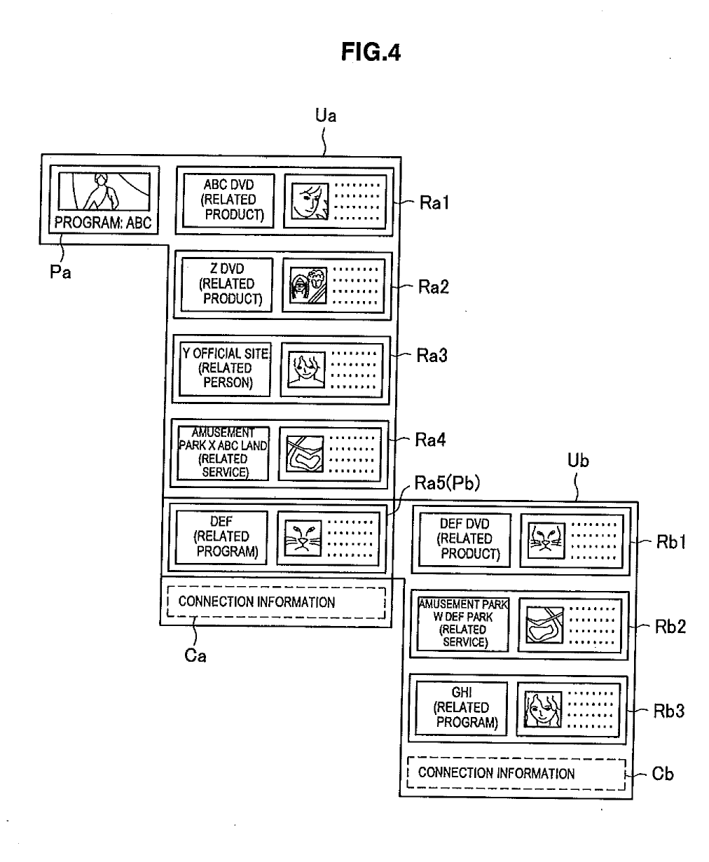

Next, the main functional configuration of the information providing apparatus 1 will be described with reference to FIGS. 2 to 4. FIG. 2 is a block diagram showing the main functional configuration of the information providing apparatus 1. FIG. 3 is a diagram showing the configuration of the database 4 and FIG. 4 is a diagram showing the configuration of the unit information U.

As shown in FIG. 2, the information providing apparatus 1 includes the database 4, a unit information receiving unit 11, an overlapping registration confirming unit 13, an overlapping registration reporting unit 15, a credibility confirming unit 17, a credibility reporting unit 19, a unit information registering unit 21, a connection rule confirming unit 23, a connection rule reporting unit 25, a unit information generating unit 27, a unit information transmitting unit 29, a usage log receiving unit 31, a usage log registering unit 33, a usage log reporting unit 35, a service providing unit 37, and an information accessing unit 39.

As shown in FIG. 3, the program information P, the program-related information R, the unit information U and the like are managed by being registered in the database 4. The program information P is typically acquired from an external database 51 managed by a program provider as information that is updated on a daily basis. The program-related information R is acquired from an external database 53 that is managed by an advertising business, product/service retailer, program provider, or the like. The unit information U may be generated by the information providing apparatus 1 itself or may be generated by the operator A via the operation terminal 2. Note that the program information P and the program-related information R themselves and/or the location(s) (URL or the like) of such information may be managed in the database 4.

As shown in FIG. 4, the unit information U is made up from the program information P, the program-related information R, and the connection information C. In the example shown in FIG. 4, the unit information Ua includes program information Pa of a program ABC, program-related information Ra1 to Ra5, and connection information Ca, and the unit information Ub includes program information Pb of a program DEF, program-related information Rb1 to Rb3, and connection information Cb. The connection information C is information that connects the program-related information R to the program information P using an ID or the like of the program-related information R.

The program information Pa, Pb include still image/moving image information of the program ABC, and information relating to the title, cast, producer, provider, release date/time, summary or the like of the program ABC. Information relating to advertisements, products, services, other programs, and the like relating to the program ABC is included in the program-related information Ra1 to Ra5, and information relating to advertisements, products, services, other programs, and the like relating to the program DEF is included in the program-related information Rb1 to Rb3. Text information, still image/moving image information, link information, and the like are included in the program-related information Ra1 to Ra5 and Rb1 to Rb3.

The program-related information Ra1 is information on a product relating to the title of the program ABC. The program-related information Ra2 is information on a product relating to a character Z mentioned in the summary of the program ABC. The program-related information Ra3 is information relating to a cast member Y of the program ABC. The program-related information Ra4 is service information relating to the title of the program ABC. The program-related information Ra5 is information relating to another program DEF by the same producer as the program ABC. The program-related information Rb1 is information on a product relating to the title of the program DEF. The program-related information Rb2 is information on a service relating to the title of the program DEF. The program-related information Rb3 is information relating to another program GHI with the same cast member as the program DEF. Note that a link to a home page may be included in the program-related information R.

The unit information U may be associated with other unit information U via the program-related information R (program information P). In the example shown in FIG. 4, since the program-related information Ra5 is information relating to the program DEF, the unit information Ua of the program ABC is associated with the unit information Ub of the program DEF via the program-related information Ra5 (that corresponds to the program information Pb). By associating the unit information Ua, Ub, the user B can seamlessly use the unit information Ua and the unit information Ub that relates to the unit information Ua.

In the information providing apparatus 1, pieces of unit information U are related automatically or semi-automatically via an operation by the operator based on the unit information U registered in the database 4. Note that the unit information U may be related to two or more pieces of unit information U, such as the unit information Ua-Ub, Ua-Uc, and the like, or may be related to other unit information U, such as the unit information Ua-Ub-Uc, so as to form a hierarchy with three or more levels.

The unit information receiving unit 11 receives, from the operation terminal 2, the unit information U generated by connecting the program-related information R to the program information P. In the operation terminal 2, the unit information U is generated by connecting the program-related information R registered in the database 4 or the program-related information R generated by the operator A to the program information P.

The connection rule confirming unit 23 confirms whether suitable program-related information R is connected to the program information P in accordance with specified connection rules. The expression “connection rules” refers to rules that are referred to to prevent programs from being connected to information (program-related information R) relating to advertisements, products, services, and the like of other companies that are rivals to the sponsor of a program, for example. Such connection rules are managed using the database 4 or the like. The connection rule reporting unit 25 generates a message showing the result of confirming the connection rules, that is, whether there has been a violation of the connection rules, and notifies the operator A of such message via the operation terminal 2.

The overlapping registration confirming unit 13 confirms whether unit information U that overlaps the unit information U that has been received is registered in the database 4. The overlapping of the unit information U is determined based on combinations of the program information P and the program-related information R. For example, when unit information Ua composed of the program information Pa and the program-related information Ra1, Ra2 has already been registered and unit information Ub composed of the program information P and the program-related information Ra1 is received, it is determined that the unit information Ua, Ub overlap one another and the operator A is urged to amend the unit information Ub. The overlapping registration reporting unit 15 generates a message showing the result of confirming overlapping registration, that is, whether overlapping unit information is already registered, and notifies the operator A of such message via the operation terminal 2.

The credibility confirming unit 17 confirms the credibility of the unit information U based on the verification information E registered in the database 4 or the external database 5. The credibility of the unit information U is confirmed by splitting the unit information U into the program information P and the program-related information R and verifying the credibility of the relationship between the program information P and the program-related information R. Note that the unit information U that has been split is restored after the credibility has been confirmed.

As one example, when some kind of actual relationship is identified between the information relating to advertisements, products, services, and other programs (i.e., the program-related information R) and the program (the program information P), it is judged that the relationship between the program information P and the program-related information R is credible and, in accordance with other confirmation results, such unit information U may be registered. The credibility reporting unit 19 generates a message showing the result of confirming the credibility, that is, whether the relationship is credible, and notifies the operator A of the message via the operation terminal 2.

The unit information generating unit 27 uses the program information P and the program-related information R registered in the database 4 and information registered in the external database 5 to connect the program-related information R to the program information P and thereby generate the unit information U. In the information providing apparatus 1, the unit information U is generated automatically or semi-automatically via an operation by an operator, and is registered in the database 4.

The unit information registering unit 21 registers the unit information U in the database 4 in accordance with the result of the determination whether to register such information. That is, when it has been confirmed that the connection rules are satisfied, there is no overlapping registration, and the relationship is credible, the unit information U is registered in the database 4. The unit information registering unit 21 also registers unit information U generated by the unit information generating unit 27 in the database 4. When the program-related information R included in the unit information U is information generated by the operator A, such program-related information R is also registered in the database 4.

The unit information transmitting unit 29 transmits the unit information U to the use terminal 3. The unit information U may be transmitted to the use terminal 3 in response to a transmission instruction or may be transmitted automatically to a use terminal 3 registered in advance. The usage log receiving unit 31 receives a usage log showing the usage of the unit information U. The usage log registering unit 33 registers the usage log in association with the unit information U in a usage log database 34. The usage log expresses usage of the unit information U for actions such as viewing advertisements relating to the program, purchasing products/services relating to the program, viewing other programs relating to the program and the like carried out via the program-related information R included in the unit information U.

The usage log reporting unit 35 notifies, via the operation terminal 2, the operator A of the usage log of the unit information U that was generated by the operator A. Based on the usage log of the unit information U generated by the operator A, the service providing unit 37 provides the operator A with a service and/or reward in keeping with the usage of the unit information U.

The information accessing unit 39 allows the operator A to access the program information P, the program-related information R, and the unit information U registered in the database 4. After acquiring access rights in advance, the operator A accesses, via the operation terminal 2, an API (Application Program Interface) that can be accessed on the information providing apparatus 1. By searching and using the program information P, the program-related information R, and the unit information U registered in the database 4 via the API, it is possible to generate unit information U that connects the program-related information R with the program information P.

The unit information receiving unit 11, the overlapping registration reporting unit 15, the credibility reporting unit 19, the connection rule reporting unit 25, the unit information transmitting unit 29, the usage log receiving unit 31, the usage log reporting unit 35, and the service providing unit 37 are configured as a communication apparatus controlled by a processor or the like. The overlapping registration confirming unit 13, the credibility confirming unit 17, the unit information registering unit 21, the connection rule confirming unit 23, the usage log registering unit 33, the information accessing unit 39, and the unit information generating unit 27 are configured as an information processing apparatus that includes a processor or the like. At least some of the functions of the structural elements described above may be realized by hardware, such as circuits, and/or may be realized by software, such as a program. When the respective structural elements are realized as software, the functions of the respective structural elements are realized by a program executed by a CPU of the information processing apparatus.

### 3. OPERATION OF INFORMATION PROVIDING SYSTEM

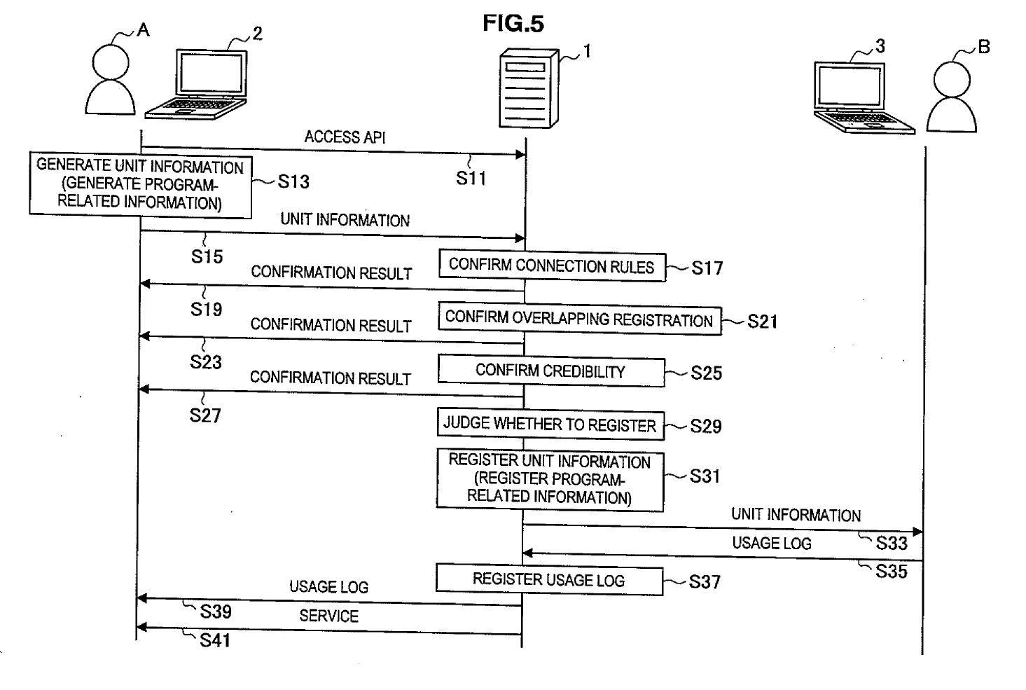

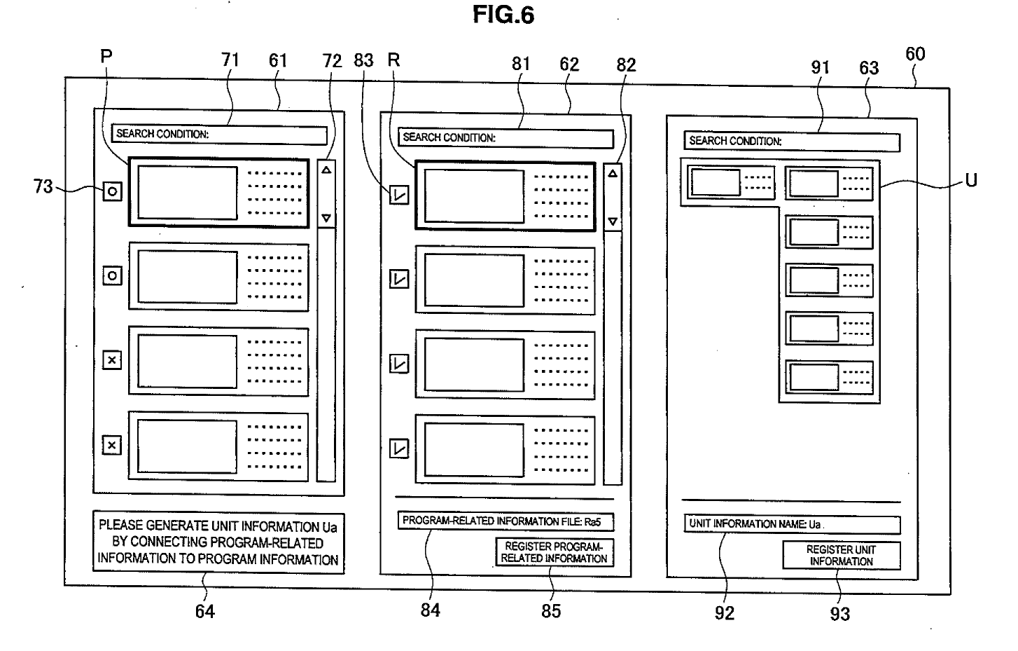

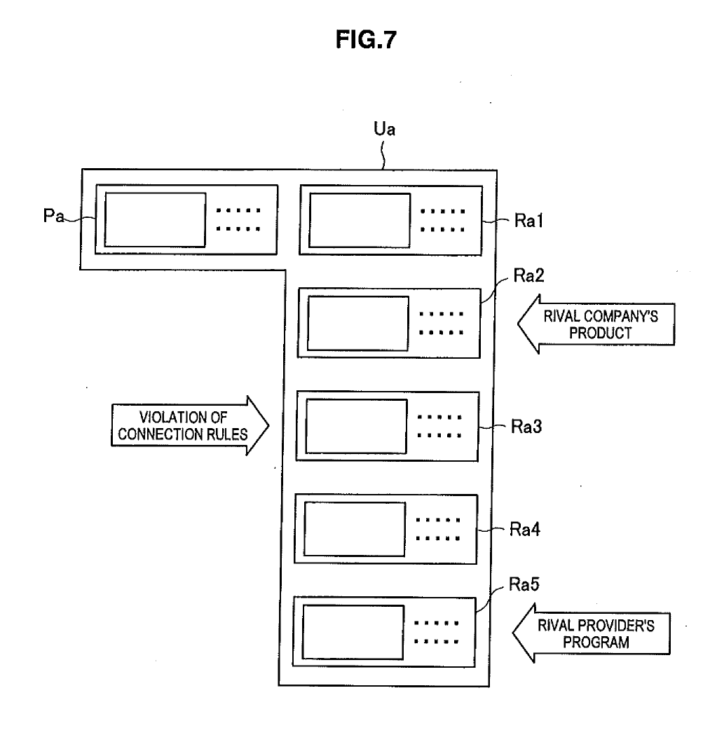

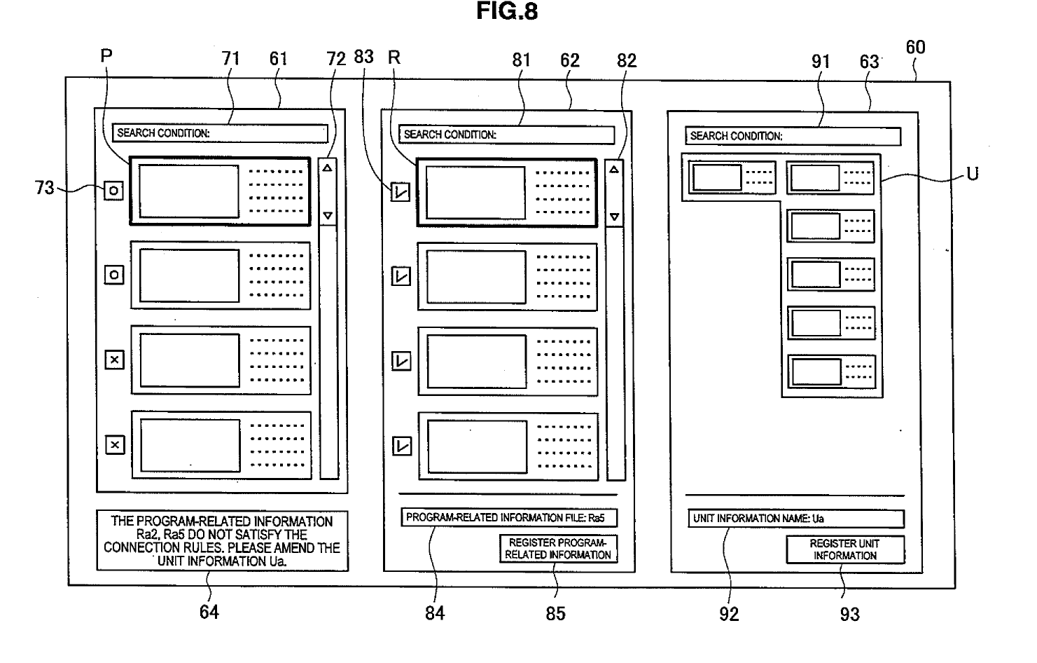

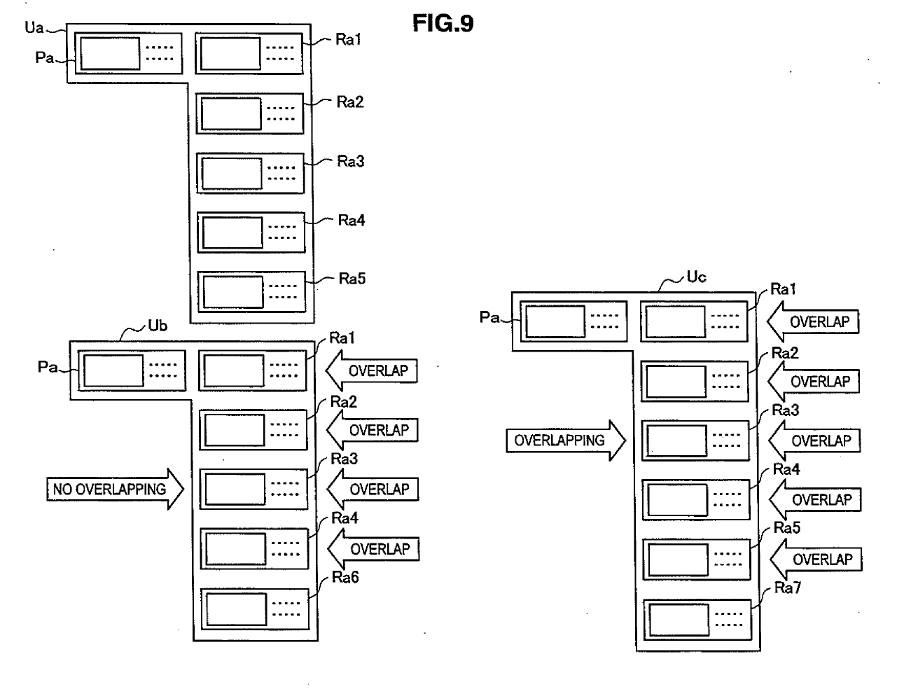

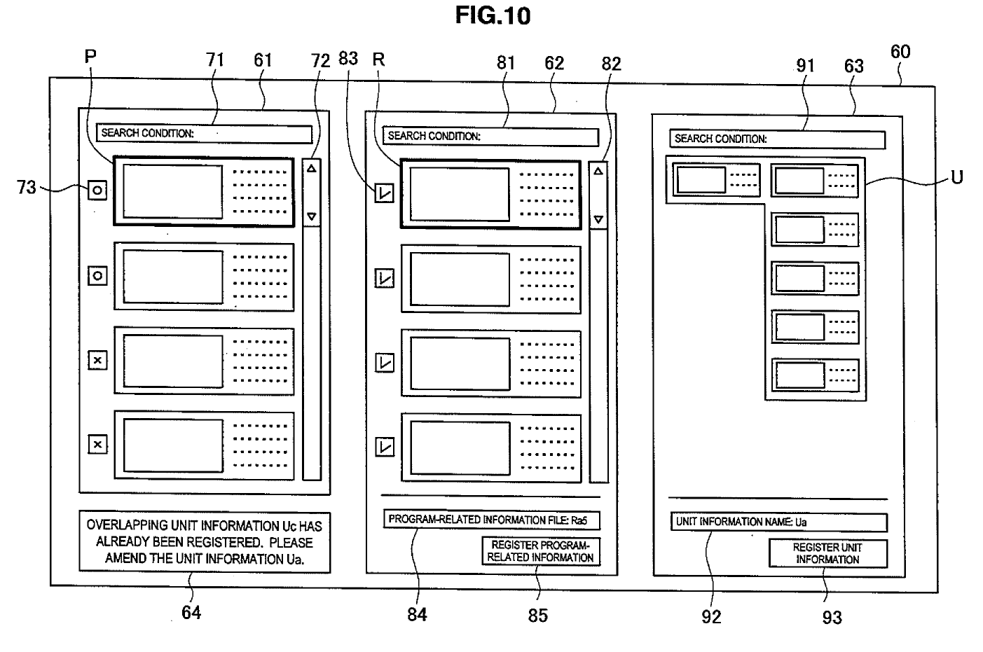

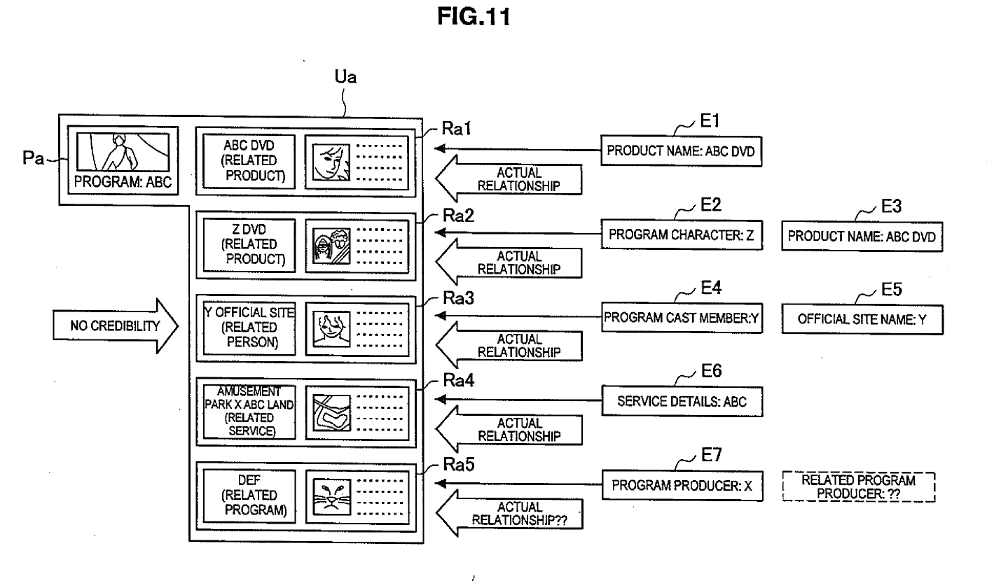

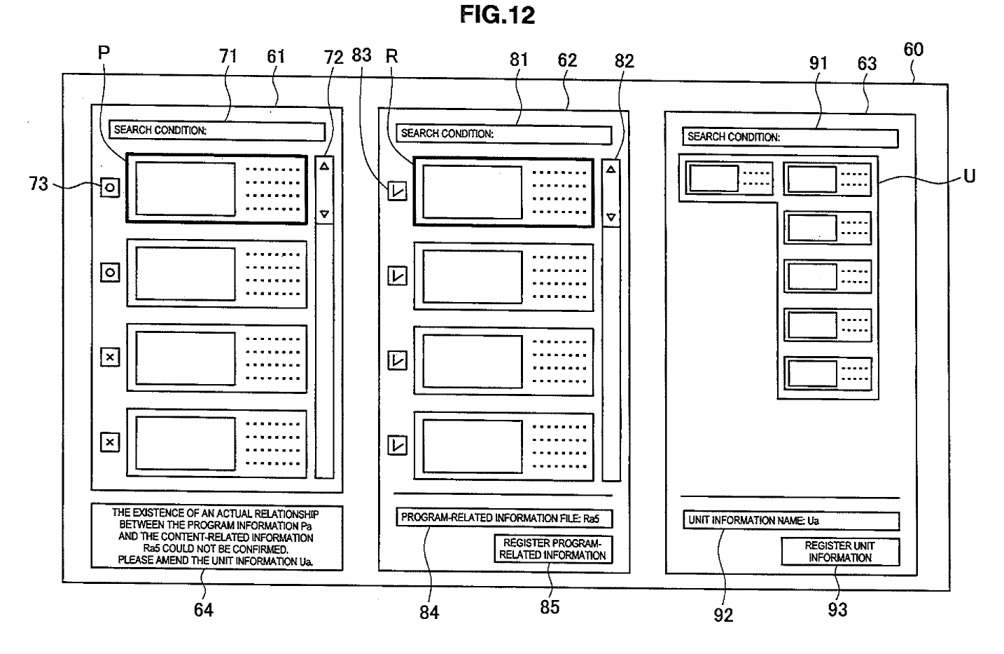

Next, the main operation of the information providing system will be described with reference to FIGS. 5 to 12. FIG. 5 is a sequence chart showing the main operation of an information providing system. FIG. 6 is a diagram schematically showing a connecting method for the program-related information R. FIG. 7 is a diagram schematically showing the result of confirming the connection rules, and FIG. 8 is a diagram showing how the result of confirming the connection rules is reported. FIG. 9 is a diagram schematically showing a result of confirming whether there is overlapping registration, and FIG. 10 is a diagram showing how the result of confirming overlapping registration is reported. FIG. 11 is a diagram schematically showing the result of confirming credibility, and FIG. 12 is a diagram showing how the result of confirming credibility is reported.

Note that although the configuration of the unit information Ua is described here as an example with reference to FIGS. 6 to 12, the present disclosure is not limited to the configuration of the unit information Ua shown in the respective drawings. Also, the program information P, the program-related information R, and the unit information U are illustrated in simplified form in FIGS. 6 to 12.

As shown in FIG. 5, first, having acquired access rights in advance, the operator A accesses the API on the information providing apparatus 1 via the operation terminal 2 (step S11).

### Generation of Unit Information U

On the operation terminal 2, the operator A uses the API to connect the program-related information R to the program information P and thereby generate the unit information U (S13). Here, the unit information U is generated by connecting at least one of program-related information R registered in the database 4 and program-related information R generated by the operator A to the program information P (the connection information C is also generated). Once the unit information U has been generated, the unit information U is transmitted to the information providing apparatus 1 (S15). Note that in place of the unit information U itself, the connection information C or a combination of the connection information C and any program-related information R generated by the operator A may be transmitted.

In FIG. 6, an operation screen 60 of the API displayed on the operation terminal 2 is shown. A display region 61 for the program information P, a display region 62 for the program-related information R, a display region 63 for the unit information U, and a message display region 64 are displayed in the operation screen 60. Note that the operation screen 60 shown in FIGS. 6, 8, 10, and 12 are mere examples of the configuration of the operation screen 60.

In the display region 61 for the program information P, the operator A is capable of designating a search condition, such as arbitrary search words, in a search condition designation box 71 to search the database 4 for program information P. The search results are scrolled on the display when a scroll bar 72 is operated. Here, each piece of program information P is displayed together with a flag 73 showing whether the connecting of program-related information R has been requested to the operator A. In FIG. 6, the flag “◯” shows that connecting has been requested, while the flag “x” shows that connecting has not been requested. The operator A is capable of selecting a piece of program information P that is being displayed together with a flag 73 set at the “connecting has been requested” state. Note that the flag 73 showing whether connecting is requested may be set at the “requested” state until a program is provided/released, for example.

In the display region 62 for the program-related information R, The operator A is capable of designating a search condition, such as arbitrary search words, in a search condition designation box 81 to search the database 4 for program-related information R. The search results are scrolled on the display when a scroll bar 82 is operated. Here, each piece of program-related information R is displayed together with a flag 83 showing whether the program-related information R has been connected to the selected program information P (displayed with a bold outline in the drawing). In FIG. 6, a flag “✓” shows that the program-related information R has been connected to the program information P. The operator A is also capable of switching the respective flags 83 showing the connected state on and off to connect suitable program-related information R to the selected program information P.

In the display region 63 for the program-related information R, the operator A is also capable of registering program-related information R that has been generated in a specified format. When a program-related information registration button 85 is operated in a state where a file (for example, the file “Ra5”) of program-related information R that has been generated in advance is designated in a file designation box 84, a registration process is carried out by the information providing apparatus 1. In such registration process, it is confirmed whether the program-related information R is suitable for use in generating unit information U and only suitable program-related information R is registered. The registered program-related information R (displayed with a bold outline in the drawing) is displayed in the display region 63 for the program-related information R. Note that program-related information R generated by the operator A may be used in generation of the unit information U by a service provider or by the operator A.

In the display region 63 for the unit information U, the operator A is capable of confirming which program-related information R is connected, that is, what unit information U is being generated. When unit information U is generated, the name of the unit information U (for example, unit information “Ua”) is designated in a name designation box 92. On completing the generation of the unit information U, the operator A is capable of operating a unit information registration button 93 to transmit the generated unit information U to the information providing apparatus 1. The operator A is also capable of designating a search condition, such as arbitrary search words, in a search condition designating box 91 to search the database 4 for unit information U.

In the example shown in FIG. 6, the connecting of program-related information R to the program information P selected in the display region 61 for the program information P is being carried out. In this example, five program-related information R, including the program-related information Ra5 generated by the operator A, have been connected to the program information P. The unit information U shown in the display region 63 for the unit information U is also being generated.

### Confirming the Connection Rules

In the information providing apparatus 1, it is confirmed whether suitable program-related information R is connected to the program information P in accordance with specified connection rules (S17). The operator A is notified of the result of confirming the connection rules via the operation terminal 2 (S19).

In the information providing apparatus 1, when the unit information U has been received, the program sponsors and/or service provider is/are confirmed based on the program information P and providers of the advertisements, products, services and other programs in the program-related information R are confirmed based on the program-related information R. As examples, it is then confirmed, based on the connection rules, that program-related information R relating to advertisements, products, services, and the like of other companies that are rivals to the program sponsors and program-related information R relating to programs of other companies that are rivals to the provider of the program are not connected. The connection rules are prepared in advance as information that restricts competition between sponsors and competition between providers.

In the example shown in FIG. 7, the program-related information Ra1 to Ra5 are connected to the program information Pa. Here, as examples, the program-related information Ra2 is information relating to a product of another company that competes with the sponsor of the program ABC and the program-related information Ra5 is a program of another company that competes with the provider of the program ABC. Accordingly, the program-related information Ra2 and Ra5 violate the connection rules.

In this case, a message showing the result of confirming the connection rules is generated in the information providing apparatus 1. As shown in FIG. 8, the operator A is notified of a message such as “The program-related information Ra2 and Ra5 do not satisfy the connection rules. Please amend the unit information Ua.” via the message display region 64 of the operation screen 60. Here, the operator A may also be notified of the details of the judgment result, such as the sponsor and the provider of the program-related information Ra2 and Ra5. After amendment of the unit information Ua has been carried out, the connection rules are confirmed again for the amended unit information Ua. Note that when the unit information Ua satisfies the connection rules, the user may be notified of a message showing this, but such notification is not especially necessary.

### Confirmation of Overlapping Registration

In the information providing apparatus 1, it is confirmed whether unit information U that overlaps the received unit information U is registered in the database 4 (S21). The operator A is then notified of the result of confirming overlapping registration via the operation terminal 2 (S23).

In the information providing apparatus 1, the program information P included in the received unit information U is used as a search condition to search the other unit information U registered in the database 4. Out of the unit information U that satisfies the search condition, it is confirmed whether unit information U that includes all of the program-related information R included in the received unit information U is registered in the database 4.

In the example shown in FIG. 9, the received unit information Ua includes the program information Pa and the program-related information Ra1 to Ra5. Also, the unit information Ub, Uc is registered in the database 4, with the unit information Ub including the program information Pa and the program-related information Ra1 to Ra4 and Ra6 and the unit information Uc including the program information Pa and the program-related information Ra1 to Ra5 and Ra7. Here, although the program-related information Ra5 is not included in the unit information Ub, all of the program-related information Ra1 to Ra5 is included in the unit information Uc. It is therefore judged that the unit information Ua does not overlap the unit information Ub but overlaps the unit information Uc.

In this case, a message showing the result of confirming overlapping registration is generated in the information providing apparatus 1. As shown in FIG. 10, the operator A is notified of a message such as “Overlapping unit information Uc has already been registered. Please amend the unit information Ua.” via the message display region 64 of the operation screen 60. Here, the operator A may also be notified of the details of the judgment result, such as the already-registered unit information Uc. After amendment of the unit information Ua has been carried out, the connection rules and overlapping registration are confirmed again for the amended unit information Ua. Note that when unit information that overlaps the unit information Ua has not been registered, the user may be notified of a message showing this, but such notification is not especially necessary.

### Confirmation of Credibility

In the information providing apparatus 1, the credibility of the unit information U is confirmed based on the verification information E registered in the database 4 or the external database 5 (S25). The operator A is then notified of the result of confirming the credibility via the operation terminal 2 (S27).

In the information providing apparatus 1, first, the unit information U is split into the program information P and the program-related information R. After this, the verification information E registered in the database 4 or the external database 5 is searched with element data of the program information P and element data of the program-related information R as search conditions. Here, the expression “element data” refers to the smallest unit of data that can be used as a search condition. As examples, the element data may be a program title, or may be words or phrases extracted by carrying out a process such as morphological analysis on a summary of the program.

Next, it is verified whether there is some kind of direct or indirect actual relationship between the program information P and the program-related information R. When confirming the credibility, the verification information E, such as programming information, EPG information, information on news items or blog posts, that has been registered in the database 4 or the external database 5 is used in addition to the program information P and the program-related information R.

Next, the verification information E itself or words, phrases, and the like extracted by carrying out a process such as morphological analysis on the verification information E is/are used to verify whether there is some kind of direct or indirect actual relationship between the program information P and the program-related information R. When there is some kind of direct or indirect actual relationship between the program information P included in the unit information U and all of the program-related information R included in the unit information U, the credibility of the unit information U is confirmed.

In the example shown in FIG. 11, the received unit information Ua includes the program information Pa and the program-related information Ra1 to Ra5. The verification information E1 to E7 are searched to show an actual relationship between the program information Pa and the program-related information Ra1 to Ra5.

Regarding the program-related information Ra1, according to the verification information E1, the title of the program ABC is included in a product name of the program-related information Ra1. Regarding the program-related information Ra2, according to the verification information E2, a character Z is included in the program A and according to the verification information E3, the character Z is included in a product name of the program-related information Ra2. Regarding the program-related information Ra3, according to the verification information E4, an actor Y is included in the cast of the program A and according to the verification information E5, the name of an actor Y is included in the name of a public site. Regarding the program-related information Ra4, according to the verification information E6, the title of the program ABC is included in the service details of the program-related information Ra4. Accordingly, the presence of some kind of actual relationship is confirmed between the program information Pa and the program-related information Ra1 to Ra4.

Meanwhile, regarding the program-related information Ra5, although it is confirmed from the verification information E7 that the program A was produced by the producer X for example, verification information E that proves that some kind of actual relationship exists with the program information Pa, such as information showing that the program DEF relating to the program-related information Ra5 was produced by the producer X, is not found. For this reason, it is impossible to confirm that some kind of actual relationship exists between the program information Pa and the program-related information Ra5 and therefore judged that the unit information Ua is not credible.

In such case, in the information providing apparatus 1, a message showing the result of confirming credibility is generated. As shown in FIG. 12, the operator A is notified of a message such as “The existence of an actual relationship between the program information Pa and the program-related information Ra5 could not be confirmed. Please amend the unit information Ua.” via the message display region 64 of the operation screen 60. Here, the operator A may also be notified of the details of the judgment result, for example, a list or the like of the verification information E found for the program-related information Ra5. After amendment of the unit information Ua has been carried out, the connection rules, overlapping registration, and credibility are confirmed again for the amended unit information Ua. Note that when the credibility of the unit information Ua has been confirmed, the user may be notified of a message showing this, but such notification is not especially necessary.

Here, unit information U for which credibility has not been confirmed may be provisionally registered in the database 4 for a specified period, such as until the program is released/starts, and may subsequently be registered in the database 4 if the credibility is confirmed within such specified period. Such provisional registration may be carried out because the program information P is information that is updated on a daily basis, and therefore there can be cases where verification information E that proves an actual relationship would be found if registration of such unit information U were attempted after the program information P is updated.

### Registration of Unit Information U

After this, in the information providing apparatus 1, it is judged whether it is possible to register the unit information U (S29). When it has been confirmed that the connection rules are satisfied, there is no overlapping registration, and the unit information U is credible, the unit information U is registered in the database 4 (S31). Here, when the unit information U is registered, in addition to the registration of the unit information U composed of the program information P, the program-related information R, and the connection information C, information on the operator A who registered the unit information U is registered. Note that any program-related information R that was generated by the operator A is also registered.

In the information providing apparatus 1, the unit information U is provided to the user B (S33) and a usage log showing usage of the unit information U is then received (S35). The usage log expresses usage of the unit information U for actions such as viewing advertisements relating to a program, purchasing of products and services relating to the program, viewing other programs relating to the program, and the like carried out via the program-related information R included in the unit information U. The usage log is registered in the database 4 or the usage log database 34 or the like in association with the unit information U (S37). Note that an advertiser, a product/service provider, and/or a program provider may be notified of the usage log from the use terminal 3 without the information providing apparatus 1 being notified.

Usage logs may be displayed on the operation screen of the API together with search results for unit information U. By referring to unit information U with high usage, the operator A can learn how to generate better unit information U.

With the information providing apparatus 1, the usage log of the unit information U generated by the operator A is reported to the operator A via the operation terminal 2 (S39). The usage log may be reported to an operation terminal 2 in accordance with instructions from the operator A, or may be regularly reported to an operation terminal 2 registered in advance.

With the information providing apparatus 1, a service or reward in keeping with the usage of the unit information U is provided to the operator A based on the usage log of the unit information U generated by the operator A (S41). The service or reward may be provided to the operator A in accordance with an invoice from the operator A or may be regularly provided to an operator A registered in advance. Note that the service or reward may be provided from the provider of the program-related information R in place of the information providing apparatus 1 or together with the information providing apparatus 1.

### 4. CONCLUSION

As described above, according to the information providing apparatus 1 and the information providing method according to the present embodiment of the disclosure, by eliminating overlapping registration of the unit information U and maintaining credibility for the unit information U, it is possible to provide high-quality unit information U where suitable program-related information R that satisfies the demands of the user B is connected to the program information P.

Although preferred embodiments of the present disclosure have been described in detail with reference to the attached drawings, the present disclosure is not limited to the above examples. It should be understood by those skilled in the art that various modifications, combinations, sub-combinations and alterations may occur depending on design requirements and other factors insofar as they are within the scope of the appended claims or the equivalents thereof.

For example, the above explanation describes the case where confirmation of the connection rules, confirmation of overlapping registration, and confirmation of credibility are carried out after the unit information U has been transmitted. However, confirmation of the connection rules and/or confirmation of overlapping registration may be carried out before the unit information U is transmitted. For example, confirmation of the connection rules may be carried out when a flag 83 showing the connected state is operated in the display region 62 for the program-related information R. Also, by displaying unit information U being generated together with similar unit information U, generation of unit information U for which a judgment of overlapping registration would be given can be prevented from the outset.

Also, in the explanation given above, the case where related information relating to a program as content is provided to the user together with the program information is described. However, the same explanation also applies to a case where related information that relates to content is provided to the user together with content information for content such as book media, music media, video media, game media, or the like instead of a program.

The present application contains subject matter related to that disclosed in Japanese Priority Patent Application JP 2010-135056 filed in the Japan Patent Office on Jun. 14, 2010, the entire content of which is hereby incorporated by reference.

What is claimed is:

1. An information processing apparatus comprising:
a database in which content information, content-related information, and unit information are registered;
a unit information receiving unit receiving the unit information, which has been generated by connecting the content-related information to the content information, from an operation terminal;
an overlapping registration confirming unit confirming whether unit information that overlaps the received unit information is registered in the database;
an overlapping registration notifying unit notifying, via the operation terminal, an operator of a confirmation result of the overlapping registration confirming unit;
a credibility confirming unit operable when overlapping registration has not been found, to confirm credibility of the unit information based on verification information registered in one of the database and an external database;
a credibility notifying unit notifying, via the operation terminal, the operator of a confirmation result of the credibility checking unit; and
a unit information registering unit registering the unit information whose credibility has been confirmed in the database.

2. An information processing apparatus according to claim 1,
wherein the credibility confirming unit splits the unit information into the content information and the content-related information and verifies credibility of a relationship between the content information and the content-related information based on the verification information registered in one of the database and the external database.

3. An information processing apparatus according to claim 1,
wherein the unit information registering unit provisionally registers unit information whose credibility has not been confirmed for a specified period and is operable when the credibility has been confirmed within the specified period, to register the unit information whose credibility has been confirmed in the database.

4. An information processing apparatus according to claim 1, further comprising:
a connection rule confirming unit confirming whether suitable content-related information has been connected to the content information according to specified connection rules; and
a connection rule notifying unit notifying, via the operation terminal, the operator of a confirmation result of the connection rule confirming unit.

5. An information processing apparatus according to claim 1,
wherein the unit information receiving unit receives, from the operation terminal, unit information generated by connecting at least one of content-related information registered in the database and content-related information generated by the operator to the content information.

6. An information processing apparatus according to claim 5,
wherein the unit information receiving unit receives content-related information generated by the operator from the operation terminal, and
the unit information registering unit registers the received content-related information in the database.

7. An information processing apparatus according to any of claim 1, further comprising an information accessing unit allowing the operator to access the content information, the content-related information, and the unit information registered in the database to enable the operator to generate the unit information.

8. An information processing apparatus according to claim 1, further comprising:
a unit information transmitting unit transmitting the unit information to a use terminal;
a usage log receiving unit receiving, from the use terminal, a usage log showing usage of the user information; and
a usage log registering unit registering the usage log in association with the unit information.

9. An information processing apparatus according to claim 8, further comprising a usage log notifying unit notifying, via the operation terminal, the operator of the usage log of the unit information generated by the operator.

10. An information processing apparatus according to claim 8,
further comprising a service providing unit providing, based on the usage log of the unit information generated by the operator, the operator with a service in keeping with usage of the unit information.

11. An information processing method carried out by a computer, comprising steps of:
receiving unit information, which has been generated by connecting content-related information to content information, from an operation terminal;
confirming whether unit information that overlaps the received unit information is registered in a database;
notifying, via the operation terminal, an operator of a confirmation result for overlapping registration;
confirming, when overlapping registration has not been found, credibility of the unit information based on verification information registered in one of the database and an external database;
notifying, via the operation terminal, the operator of a confirmation result for the credibility; and
registering the unit information whose credibility has been confirmed in the database.

12. A program for causing a computer to execute the information processing method according to claim 11.
